(19) United States
(12) Patent Application Publication
(10) Pub. No.: US 2026/0034725 A1
(43) Pub. Date: Feb. 5, 2026

(54) THREE-DIMENSIONAL SHAPING APPARATUS

(71) Applicant: SEIKO EPSON CORPORATION, Tokyo (JP)

(72) Inventor: Junhua ZHANG, SHIOJIRI-SHI (JP)

(21) Appl. No.: 19/282,216

(22) Filed: Jul. 28, 2025

(30) Foreign Application Priority Data
Jul. 31, 2024 (JP) 2024-124459

(51) Int. Cl. B29C 64/209; B29C 64/245; B29C 64/295; B33Y 30/00

(52) U.S. Cl. CPC B29C 64/209; B29C 64/245; B29C 64/295; B33Y 30/00

(57) ABSTRACT

A three-dimensional shaping apparatus includes a plasticizing unit configured to generate a plasticized material, a flow path forming unit including a flow path through which the plasticized material flows, a nozzle coupled to the flow path forming unit and configured to eject the plasticized material, and a heating unit provided to the flow path forming unit and configured to heat the plasticized material. The nozzle includes an introduction port communicating with the flow path and is configured to introduce the plasticized material and an ejection port communicating with the introduction port and configured to eject the plasticized material. A length of the nozzle in a direction orthogonal to a direction of a center line and pas through a center of the introduction port and a center of the ejection port is equal to or more than twice a length thereof in the direction of the center line.

The present application is based on, and claims priority from JP Application Serial Number 2024-124459, filed Jul. 31, 2024, the disclosure of which is hereby incorporated by reference herein in its entirety.

### BACKGROUND

### 1. Technical Field

The present disclosure relates to a three-dimensional shaping apparatus.

### 2. Related Art

There has been known a three-dimensional shaping apparatus that shapes a three-dimensionally shaped object by ejecting a plasticized material from a nozzle onto a stage and curing the material.

For example, JP-A-2023-107401 describes a three-dimensional shaping apparatus including a nozzle unit that ejects a material, a main body unit that includes a flow path of the material and to which the nozzle unit is attached, and a platform on which the material ejected from the nozzle unit is stacked.

In the three-dimensional shaping apparatus described above, depending on the shape of the nozzle unit, heat from a heating unit that heats the material may not be efficiently transmitted to the distal end of the nozzle unit. As a result, the temperature at the tip of the nozzle unit may drop below a temperature suitable for ejecting the material.

### SUMMARY

According to an aspect of the present disclosure, a three-dimensional shaping apparatus includes a plasticizing unit configured to plasticize a material and generate plasticized material, a flow path forming unit communicating with the plasticizing unit and including a flow path through which the plasticized material flows, a nozzle being coupled to the flow path forming unit and being configured to eject the plasticized material, and a heating unit being provided to the flow path forming unit and being configured to heat the plasticized material, wherein the nozzle includes an introduction port communicating with the flow path and being configured to introduce the plasticized material, and an ejection port communicating with the introduction port and being configured to eject the plasticized material, and a length of the nozzle in a direction orthogonal to a direction of a center line passing through a center of the introduction port and a center of the ejection port is equal to or more than twice a length thereof in the direction of the center line.

According to an aspect of the present disclosure, a three-dimensional shaping apparatus includes a plasticizing unit configured to plasticize a material and generate plasticized material, a flow path forming unit communicating with the plasticizing unit and including a flow path through which the plasticized material flows, a nozzle being coupled to the flow path forming unit and being configured to eject the plasticized material, and a heating unit being provided to the flow path forming unit and being configured to heat the plasticized material, wherein the nozzle includes an introduction port communicating with the flow path and being configured to introduce the plasticized material, and an ejection port communicating with the introduction port and being configured to eject the plasticized material, and all side surfaces of the nozzle are positioned outside a cone having an apex at the center of the ejection port, a height equal to a distance between the center of the introduction port and the center of the ejection port, and a right vertex angle.

### BRIEF DESCRIPTION OF THE DRAWINGS

FIG. 1 is a cross-sectional view schematically illustrating a three-dimensional shaping apparatus according to the embodiment.

FIG. 2 is a perspective view schematically illustrating a flat screw of the three-dimensional shaping apparatus according to the embodiment.

FIG. 3 is a plan view schematically illustrating a barrel of the three-dimensional shaping apparatus according to the embodiment.

FIG. 4 is a diagram schematically illustrating a nozzle unit and a stage of the three-dimensional shaping apparatus according to the embodiment.

FIG. 5 is a flowchart for describing an operation of the three-dimensional shaping apparatus according to the embodiment.

FIG. 6 is a cross-sectional view for describing shaped layer formation processing of the three-dimensional shaping apparatus according to the embodiment.

FIG. 7 is a diagram schematically illustrating a nozzle unit of a three-dimensional shaping apparatus according to a first modification example of the embodiment.

FIG. 8 is a diagram schematically illustrating a nozzle unit of a three-dimensional shaping apparatus according to a second modification example of the embodiment.

FIG. 9 is a diagram schematically illustrating a nozzle unit of a three-dimensional shaping apparatus according to a third modification example of the embodiment.

FIG. 10 is a diagram for describing a result of a simulation.

### DESCRIPTION OF EMBODIMENTS

A preferred embodiment of the present disclosure is described in detail below with reference to the drawings. The embodiment to be described below does not unduly limit the content of the present disclosure described in the claims. In addition, not all the configurations described below are essential constituent elements of the present disclosure.

### 1. Three-Dimensional Shaping Apparatus

### 1.1. Overall Configuration

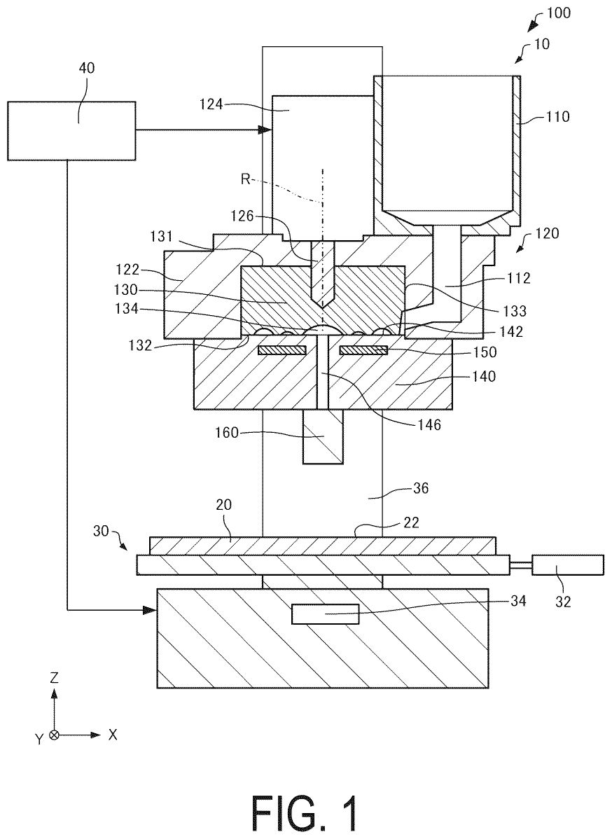

First, a three-dimensional shaping apparatus according to the embodiment is described with reference to the drawings. FIG. 1 is a cross-sectional view schematically illustrating a three-dimensional shaping apparatus 100 according to the embodiment. Note that, in FIG. 1, an X-axis, a Y-axis, and a Z-axis are illustrated as three axes orthogonal to one another. The X-axis direction and the Y-axis direction are horizontal directions, for example. The Z-axis direction is a vertical direction, for example.

As illustrated in FIG. 1, for example, the three-dimensional shaping apparatus 100 includes an ejection unit 10, a stage 20, a position changing unit 30, and a control unit 40.

The three-dimensional shaping apparatus 100 drives the position changing unit 30 to change a relative position between the ejection unit 10 and the stage 20 while ejecting a plasticized material, which is obtained through plasticization, from the ejection unit 10 onto the stage 20. With this, the three-dimensional shaping apparatus 100 shapes a three-dimensionally shaped object having a desired shape on the stage 20. The three-dimensional shaping apparatus 100 is a three-dimensional shaping apparatus of a fused deposition modeling (FDM) (registered trademark) type.

Although not elaborated in the drawings, a plurality of ejection units 10 may be provided. For example, two ejection units 10 may be provided. In such a case, both of the two ejection units 10 may eject the plasticized material for forming a three-dimensionally shaped object. Alternatively, one of them may eject the plasticized material, and the other may eject a support material for supporting a three-dimensionally shaped object. The two ejection units 10 may be arrayed in the X-axis direction.

The discharge unit 10 includes, for example, a material storage unit 110, a plasticizing unit 120, and a nozzle unit 160. Note that, for the sake of convenience, the nozzle unit 160 is illustrated in a simplified manner in FIG. 1.

The material storage unit 110 stores a material in a pellet form or a powder form. The material storage unit 110 supplies the material to the plasticizing unit 120. For example, the material storage unit 110 is configured by a hopper. The material stored in the material storage unit 110 is an acrylonitrile butadiene styrene (ABS) resin, for example.

The material storage unit 110 and the plasticizing unit 120 are coupled to each other via a supply path 112 provided below the material storage unit 110. The material that is put into the material storage unit 110 is supplied to the plasticizing unit 120 via the supply path 112.

For example, the plasticizing unit 120 includes a screw case 122, a driving motor 124, a flat screw 130, a barrel 140, and a heating unit 150. The plasticizing unit 120 plasticizes a solid material supplied from the material storage unit 110, generates a paste-like plasticized material having fluidity, and supplies the plasticized material to the nozzle unit 160.

Note that the term “plasticization” indicates a concept that includes melting, and refers to changing a solid into a state with fluidity. Specifically, for a material that undergoes glass transition, plasticization refers to raising a temperature of the material above the glass transition point. For a material that does not undergo glass transition, plasticization refers to raising a temperature of the material above the melting point.

The screw case 122 is a housing that accommodates the flat screw 130. A barrel 140 is provided on the lower surface of the screw case 122. The flat screw 130 is stored in a space surrounded by the screw case 122 and the barrel 140.

The driving motor 124 is provided at an upper surface of the screw case 122. The driving motor 124 is a servo motor, for example. A shaft 126 of the driving motor 124 is coupled to an upper surface 131 of the flat screw 130. The driving motor 124 is controlled by the control unit 40. Note that, although not elaborated in the drawing, the shaft 126 of the driving motor 124 and the upper surface 131 of the flat screw 130 may be coupled to each other via a speed reducer.

The flat screw 130 has a substantially columnar shape in which a size in a direction of the rotation axis R is smaller than a size in a direction orthogonal to the direction of the rotation axis R. In the illustrated example, the rotation axis R is parallel to the Z axis. The driving motor 124 generates a torque to rotate the flat screw 130 about the rotation axis R.

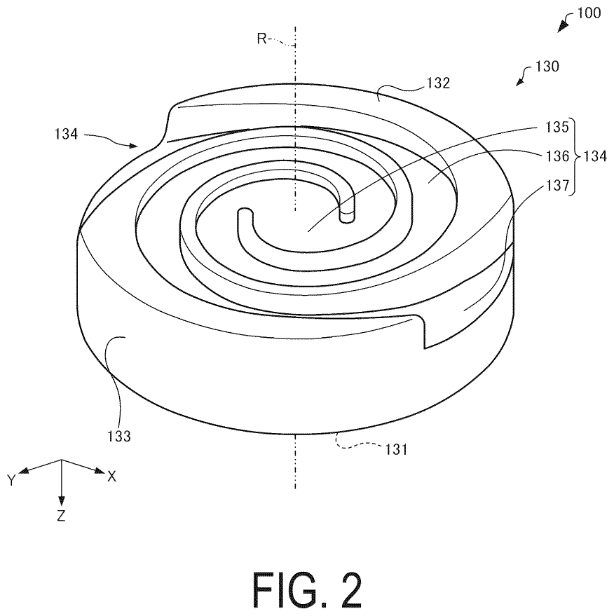

The flat screw 130 includes the upper surface 131, a groove formation surface 132 opposite to the upper surface 131, and a side surface 133 that couples the upper surface 131 and the groove formation surface 132 to each other. The groove forming surface 132 has a first groove 134. For example, the side surface 133 is vertical with respect to the groove formation surface 132. Here, FIG. 2 is a perspective view schematically illustrating the flat screw 130. Note that, for the sake of convenience, FIG. 2 illustrates a state in which the positional relationship is inverted vertically from that illustrated in FIG. 1.

As illustrated in FIG. 2, the first groove 134 is formed in the groove formation surface 132 of the flat screw 130. For example, the first groove 134 includes a center portion 135, a coupling portion 136, and a material guiding portion 137. The center portion 135 faces a communication hole 146 formed in the barrel 140. The central portion 135 communicates with the communication hole 146. The coupling portion 136 couples the center portion 135 and the material guiding portion 137 to each other. In the illustrated example, the coupling portion 136 is provided spirally from the center portion 135 toward the outer periphery of the groove formation surface 132. The material guiding portion 137 is provided to the outer periphery of the groove formation surface 132. In other words, the material guiding portion 137 is provided to the side surface 133 of the flat screw 130. The material supplied from the material storage unit 110 is guided from the material guiding portion 137 to the first groove 134, passes through the coupling portion 136 and the center portion 135, and is transported to the communication hole 146 formed in the barrel 140. For example, two first grooves 134 are provided.

Note that the number of first grooves 134 is not particularly limited. Although not elaborated in the drawing, three or more first grooves 134 may be formed, or only one first groove 134 may be formed.

Further, although not elaborated in the drawing, the plasticizing unit 120 may include an elongated in-line screw having a helical screw on its side surface, in place of the flat screw 130. Further, the plasticizing unit 120 may plasticize the material by rotation of the in-line screw. However, in view of size reduction of the apparatus, the flat screw 130 may be used.

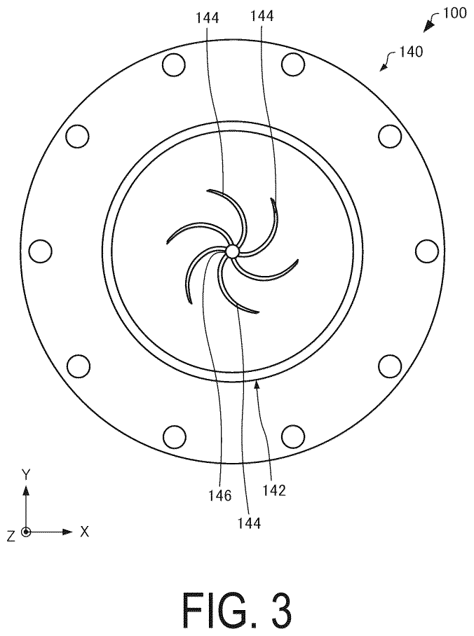

As illustrated in FIG. 1, the barrel 140 is provided below the flat screw 130. The barrel 140 includes a counter surface 142 facing the groove formation surface 132 of the flat screw 130. The communication hole 146 communicating with the first groove 134 is formed at the center of the counter surface 142. Here, FIG. 3 is a plan view schematically illustrating the barrel 140.

As illustrated in FIG. 3, a second groove 144 and the communication hole 146 are formed in the counter surface 142 of the barrel 140. A plurality of second grooves 144 are formed. In the illustrated example, six second grooves 144 are formed, and the number of second grooves 144 is not particularly limited. The plurality of second grooves 144 are formed in the periphery of the communication hole 146 as viewed in the Z-axis direction. The second groove 144 includes one end coupled to the communication hole 146, and extends spirally from the communication hole 146 to the outer periphery of the barrel 140. The second groove 144 includes a function of guiding the plasticized material, which is obtained through plasticization, to the communication hole 146.

Note that the shape of the second groove 144 is not particularly limited, and may be a linear shape, for example. Further, the one end of the second groove 144 may not be coupled to the communication hole 146. Further, the second groove 144 may not be formed in the counter surface 142. However, in view of efficient introduction of the plasticized material to the communication hole 146, the second groove 144 may be formed in the counter surface 142.

As illustrated in FIG. 1, the heating unit 150 is provided to the barrel 140. The heating unit 150 is a heater. The heating unit 150 is a rod heater, for example. The heating unit 150 heats the material supplied between the flat screw 130 and the barrel 140. The output of the heating unit 150 is controlled by the control unit 40. The plasticizing unit 120 heats the material while transporting the material toward the communication hole 146 through the flat screw 130, the barrel 140, and the heating unit 150. Thus, the plasticized material, which is obtained through plasticization, is generated. Further, the plasticizing unit 120 causes the plasticized material thus generated to flow out from the communication hole 146. Note that, as viewed in the Z-axis direction, the shape of the heating unit 150 may be a ring-like shape.

The plasticized material is supplied to the nozzle unit 160 from the communication hole 146. The nozzle unit 160 ejects the plasticized material thus supplied onto the stage 20. Details of the nozzle unit 160 are described later.

The stage 20 is provided below the nozzle unit 160. In the illustrated example, the shape of the stage 20 is a rectangular parallelepiped shape. The stage 20 includes a stacking surface 22 on which the plasticized material is stacked. The stacking surface 22 is a region of the upper surface of the stage 20. The material of the stage 20 is metal such as aluminum.

The position changing unit 30 supports the stage 20. The position changing unit 30 changes the relative position between the ejection unit 10 and the stage 20. In the illustrated example, the position changing unit 30 changes the relative position between the nozzle unit 160 and the stage 20 in the X-axis direction and the Y-axis direction by moving the stage 20 in the X-axis direction and the Y-axis direction. Further, the position changing unit 30 changes the relative position between the nozzle unit 160 and the stage 20 in the Z-axis direction by moving the ejection unit 10 in the Z-axis direction.

For example, the position changing unit 30 includes a first electric actuator 32, a second electric actuator 34, and a third electric actuator 36. The first electric actuator 32 moves the stage 20 in the X-axis direction. The second electric actuator 34 moves the stage 20 in the Y-axis direction. The third electric actuator 36 moves the ejection unit 10 in the Z-axis direction.

Note that the configuration of the position changing unit 30 is not particularly limited as long as the relative position between the ejection unit 10 and the stage 20 can be changed. For example, the position changing unit 30 may be configured to move the stage 20 in the Z-axis direction and move the ejection unit 10 in the X-axis direction and the Y-axis direction. Alternatively, the position changing unit 30 may be configured to move the stage 20 or the ejection unit 10 in the X-axis direction, the Y-axis direction, and the Z-axis direction.

The control unit 40 is configured by a computer including a processor, a main storage apparatus, and an input/output interface for performing input and output of signals with external parts, for example. The control unit 40 implements various functions with the processor executing the program read in the main storage apparatus, for example. Specifically, the control unit 40 controls the ejection unit 10 and the position changing unit 30. Note that the control unit 40 may be configured by a combination of a plurality of circuits, not the computer.

### 1.2. Nozzle Unit

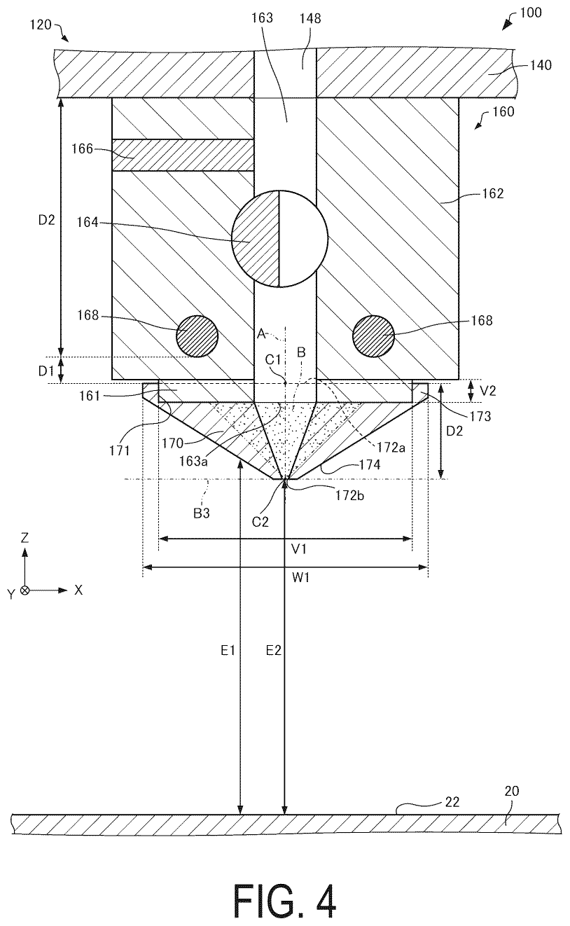

FIG. 4 is a cross-sectional view schematically illustrating the nozzle unit 160 and the stage 20.

As illustrated in FIG. 4, for example, the nozzle unit 160 includes a flow path forming unit 162, a butterfly valve 164, a pressure sensor 166, a heating unit 168, and a nozzle 170.

The flow path forming unit 162 is coupled to the barrel 140. The flow path forming unit 162 is a substantially rectangular parallelepiped shape, for example. For example, the material of the flow path forming unit 162 is Steel Use Stainless (SUS).

The flow path forming unit 162 includes a flow path 163. The flow path 163 communicates with the plasticizing unit 120. Specifically, the flow path 163 communicates with the communication hole 146 of the barrel 140. The plasticized material from the plasticizing unit 120 flows to The flow path 163.

The butterfly valve 164 is provided in the flow path 163. The butterfly valve 164 adjusts the flow rate of the plasticized material flowing through the flow path 163. The butterfly valve 164 is driven by a driving unit, which is omitted in illustration. The driving unit is controlled by the control unit 40.

The pressure sensor 166 is provided to the flow path forming unit 162. The pressure sensor 166 detects the pressure of the flow path 163. Information on the pressure detected by the pressure sensor 166 is transmitted to the control unit 40. For example, the control unit 40 adjusts the butterfly valve 164, based on the received information on the pressure.

The heating unit 168 is provided in the flow path forming unit 162. The heating unit 168 is a heater, for example. The heating unit 168 may be a rod heater or a ring-shaped heater. In the illustrated example, the heating unit 168 is a rod heater, and the flow path 163 is provided between the two heating units 168.

The heating unit 168 is located closer to the nozzle 170 than the plasticizing unit 120. In other words, the distance D1 between the nozzle 170 and the heating unit 168 is less than the distance D2 between the plasticizing unit 120 and the heating unit 168. The heating unit 168 heats the plasticized material by heating the flow path forming unit 162 and the nozzle 170. The output of the heating unit 168 is controlled by the control unit 40. The set temperature of the heating unit 168 may be higher than the set temperature of the heating unit 150 of the plasticizing unit 120.

The nozzle 170 is coupled to the flow path forming unit 162. For example, the nozzle 170 is removably attached to the flow path forming unit 162. With this, when the nozzle 170 is degraded, the nozzle 170 can be replaced. For example, the thermal conductivity of the nozzle 170 is higher than the thermal conductivity of the flow path forming unit 162. The material of the nozzle 170 is metal such as copper (Cu), aluminum (Al), and platinum (Pt).

The nozzle 170 discharges the plasticized material. The nozzle 170 has a nozzle hole 172. The nozzle hole 172 communicates with the flow path 163 of the flow path forming unit 162. The nozzle hole 172 includes an introduction port 172a and an ejection port 172b. The introduction port 172a communicates with the flow path 163. The introduction port 172a introduced the plasticized material from the flow path 163 to the nozzle hole 172. The ejection port 172b communicates with the introduction port 172a. The ejection port 172b ejects the plasticized material. The diameter of the ejection port 172b is smaller than the diameter of the introduction port 172a. The ejection port 172b is provided to the distal end of the nozzle 170. As viewed in the Z-axis direction, the shapes of the introduction port 172a and the ejection port 172b are circular, for example.

The nozzle 170 is screwed to the flow path forming unit 162, for example. In the illustrated example, the flow path forming unit 162 includes a first screw portion 161, and the nozzle 170 includes a second screw portion 171. Further, the second screw portion 171 is fastened with the first screw portion 161, and thus the nozzle 170 is coupled to the flow path forming unit 162. The first screw portion 161 is provided to a part corresponding to an outlet 163a of the flow path 163. The first screw portion 161 is a male screw. A length V1 of the first screw portion 161 in the X-axis direction is more than a length V2 thereof in the Z-axis direction. The second screw portion 171 is provided to a part corresponding to the introduction port 172a. The second threaded portion 171 is a female thread.

The nozzle 170 includes a peripheral portion 173 provided in the periphery of the second screw portion 171. The peripheral portion 173 surrounds the second screw portion 171. In the illustrated example, the peripheral portion 173 is separated away from the flow path forming unit 162. A gap is present between the peripheral portion 173 and the flow path forming unit 162. With the gap between the peripheral portion 173 and the flow path forming unit 162, the second screw portion 171 can be fastened more securely with the first screw portion 161.

A length W1 of the nozzle 170 in a direction orthogonal to a direction of a center line A passing through a center C1 of the introduction port 172a and a center C2 of the ejection port 172b is equal to or more than twice a length W2 thereof in the direction of the center line A. In the illustrated example, the direction of the center line A is the Z-axis direction, and the direction orthogonal to the direction of the center line A is the X-axis direction. The length W1 may be 2.3 times or more and 5 times or less the length W2, and may also be 2.5 times or more and 4 times or less the length W2. In the illustrated example, the length W1 is less than the length of the flow path forming unit 162 in the X-axis direction. The length W2 is a distance between the introduction port 172a and the ejection port 172b.

All side surfaces 174 of the nozzle 170 are positioned outside a cone B. All the side surfaces 174 of the nozzle 170 are separated away from the cone B. The cone B is a conical shape having an apex at the center C2 of the ejection port 172b, a height equal to the distance between the center C1 of the introduction port 172a and the center C2 of the ejection port 172b, and a right vertex angle.

For all the side surfaces 174 of the nozzle 170, a distance E1 between the side surface 174 of the nozzle 170 and the stacking surface 22 of the stage 20 is less than a distance E2 between the ejection port 172b and the stacking surface 22. The side surface 174 is positioned between an imaginary plane (omitted in illustration) passing through the ejection port 172b with the center line A as a vertical line and the flow path forming unit 162.

### 1.3. Operations

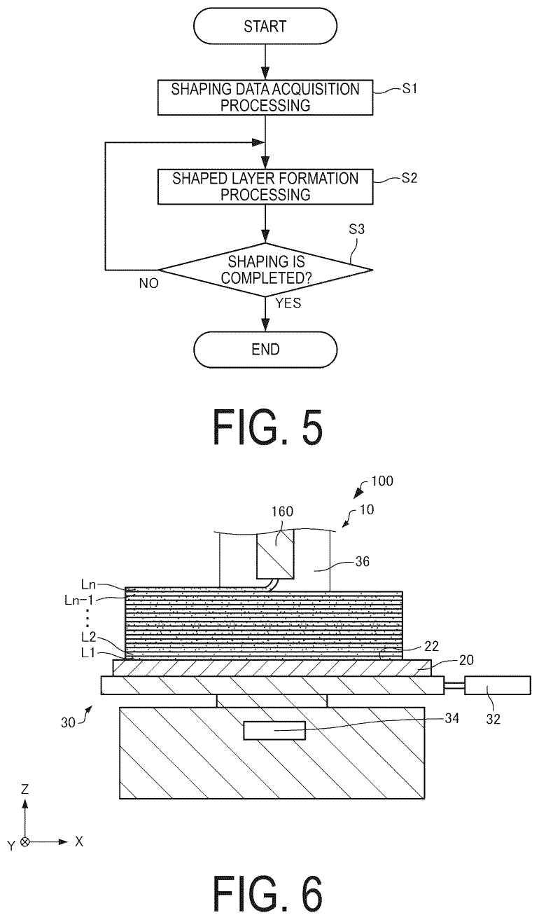

FIG. 5 is a flowchart for describing an operation of the three-dimensional shaping apparatus 100. Specifically, FIG. 5 is a flowchart for describing processing of the control unit 40.

A user outputs a processing start signal for starting the processing to the control unit 40 by operating an operation unit, which is omitted in the drawing, for example. The operation unit is composed of a mouse, a keyboard, a touch panel, and the like. When the control unit 40 receives the processing start signal, the processing is started.

First, as illustrated in FIG. 5, the control unit 40 executes shaping data acquisition processing for shaping a three-dimensionally shaped object in step S1.

For example, the shaping data includes information relating to the type of the material stored in the material storage unit 110, the moving path of the ejection unit 10 with respect to the stage 20, the amount of the plasticized material to be ejected from the ejection unit 10, and the like.

The shaping data is created by reading shape data into slicer software installed in a computer connected to the three-dimensional shaping apparatus 100, for example. The shape data is data representing an intended shape of a three-dimensionally shaped object created by using three-dimensional CAD (Computer Aided Design) software, three-dimensional CG (Computer Graphics) software and/or the like. As the shape data, data of the STL (Standard Triangulated Language) format and/or the AMF (Additive Manufacturing File Format) is used, for example. The slicer software divides the intended shape of the three-dimensionally shaped object into layers with a predetermined thickness, and creates the shaping data for each layer. The shaping data is represented by G codes and M codes. The control unit 40 acquires the shaping data from the computer connected to the three-dimensional shaping apparatus 100 or a recording medium such as a universal serial bus (USB) memory.

Subsequently, the control unit 40 executes shaped layer formation processing for ejecting the plasticized material and forming a shaped layer on the stacking surface 22 of the stage 20 in step S2.

Specifically, the control unit 40 plasticizes the material supplied between the flat screw 130 and the barrel 140 to generate the plasticized material, and causes the nozzle unit 160 of the ejection unit 10 to eject the plasticized material. For example, the control unit 40 continues generation of the plasticized material until the shaped layer formation processing is terminated.

Herein, FIG. 6 is a cross-sectional view for describing the shaped layer formation processing of the three-dimensional shaping apparatus 100. Note that, for the sake of convenience, the nozzle unit 160 is illustrated in a simplified manner in FIG. 6.

As illustrated in FIG. 6, the control unit 40 controls the position changing unit 30 to change the relative position between the ejection unit 10 and the stage 20, based on the shaping data, and simultaneously controls the ejection unit 10 to eject the plasticized material from the nozzle unit 160 onto the stage 20.

Specifically, before the shaped layer formation processing is started, in other words, before formation of a shaped layer Li being a first shaped layer is started, the nozzle unit 160 is arranged at the initial position in the −X-axis direction with respect to the end portion of the stage 20 in the −X-axis direction. As illustrated in FIG. 6, when the shaped layer formation processing is started, the control unit 40 controls the position changing unit 30 to move the nozzle unit 160 in the +X-axis direction with respect to the stage 20, for example. When the nozzle unit 160 passes above the stage 20, the plasticized material is ejected from the nozzle unit 160. With this, the shaped layer Li is formed. FIG. 6 illustrates the layers up to an n-th shaped layer Ln, where n is a freely-selected natural number.

Subsequently, as illustrated in FIG. 5, the control unit 40 executes determination processing for determining whether formation of all the shaped layers is completed, based on the shaping data, in step S3.

When it is determined that formation of all the shaped layers is not completed (“NO” in step S3), the control unit 40 returns to the processing to step S2. The control unit 40 repeats step S2 and step S3 until it is determined that formation of all the shaped layers is completed in step S3.

In contrast, when it is determined that formation of all the shaped layers is completed (“YES” in step S3), the control unit 40 terminates the processing.

### 1.4. Operation and Effects

The three-dimensional shaping apparatus 100 includes the plasticizing unit 120 that plasticizes a material and generate plasticized material, the flow path forming unit 162 that communicates with the plasticizing unit 120 and includes the flow path 163 through which the plasticized material flows, the nozzle 170 that is coupled to the flow path forming unit 162 and ejects the plasticized material, and the heating unit 168 that is provided to the flow path forming unit 162 and heats the plasticized material. The nozzle 170 includes the introduction port 172a that communicates with the flow path 163 and introduces the plasticized material to the introduction port 172a and the ejection port 172b that communicates with the introduction port 172a and ejects the plasticized material. The length W1 of the nozzle 170 in the direction orthogonal to the direction of the center line A passing through the center C1 of the introduction port 172a and the center C2 of the ejection port 172b is equal to or more than twice the length W2 thereof in the direction of the center line A.

Thus, in the three-dimensional shaping apparatus 100, the heat of the heating unit 168 is easily transmitted to the distal end of the nozzle 170 as compared to a case in which the length W1 is less than twice the length W2. Therefore, the temperature of the nozzle 170 can be stabilized, and shaping can be accurately executed. For example, in the three-dimensional shaping apparatus 100, the length W2 is equal to or less than half the length W1. Thus, the distance between the heating unit 168 and the distal end of the nozzle 170 can be reduced, and the heat of the heating unit 168 is easily transmitted to the distal end of the nozzle 170.

In the three-dimensional shaping apparatus 100, all the side surfaces 174 of the nozzle 170 are positioned outside the cone B having an apex at the center C2 of the ejection port 172b, a height equal to the distance between the center C1 of the introduction port 172a and the center C2 of the ejection port 172b, and a right vertex angle. Thus, in the three-dimensional shaping apparatus 100, the heat of the heating unit 168 is easily transmitted to the distal end of the nozzle 170 as compared to a case in which the side surfaces of the nozzle are positioned inside the cone B.

In the three-dimensional shaping apparatus 100, the flow path forming unit 162 includes the first screw portion 161 provided to the part corresponding to the outlet 163a of the flow path 163, the nozzle 170 includes the second screw portion 171 that is provided to the part corresponding to the introduction port 172a and can be fastened with the first screw portion 161, and the length V1 of the first screw portion 161 in the direction orthogonal to the direction of the center line A is more than the length V2 thereof in the direction of the center line A. Thus, in the three-dimensional shaping apparatus 100, the heat of the heating unit 168 is easily transmitted to the distal end of the nozzle 170 as compared to a case in which the length V1 is equal to or less than the length V2.

The three-dimensional shaping apparatus 100 includes the stage 20 including the stacking surface 22 on which the plasticized material is stacked. For all the side surfaces 174 of the nozzle 170, the distance E1 between the side surface 174 of the nozzle 170 and the stacking surface 22 is less than the distance E2 between the ejection port 172b and the stacking surface 22. Thus, in the three-dimensional shaping apparatus 100, the possibility that the nozzle 170 contacts the stage 20 or a shaped object can be lowered.

In the three-dimensional shaping apparatus 100, the distance D1 between the nozzle 170 and the heating unit 168 is less than the distance D2 between the plasticizing unit 120 and the heating unit 168. Thus, in the three-dimensional shaping apparatus 100, the distance between the heating unit 168 and the distal end of the nozzle 170 can be reduced, and the heat of the heating unit 168 is easily transmitted to the distal end of the nozzle 170.

In the three-dimensional shaping apparatus 100, the thermal conductivity of the nozzle 170 is higher than the thermal conductivity of the flow path forming unit 162. Thus, in the three-dimensional shaping apparatus 100, the heat of the heating unit 168 is easily transmitted to the distal end of the nozzle 170.

### 2. Modification Examples

### 2.1. First Modification Example

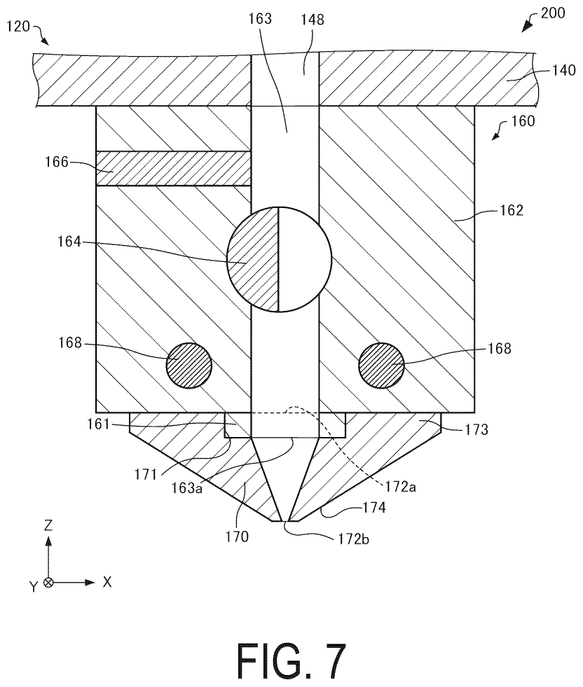

Next, a three-dimensional shaping apparatus according to a first modification example of the embodiment is described with reference to the drawings. FIG. 7 is a cross-sectional view schematically illustrating the nozzle unit 160 of a three-dimensional shaping apparatus 200 according to a first modification example of the embodiment.

In the following description, in the three-dimensional shaping apparatus 200 according to the first modification of the embodiment, members with the same functions as those of the components of the above-described three-dimensional shaping apparatus 100 according to the embodiment are denoted with the same reference numerals, and the description thereof is omitted. This also applies to three-dimensional shaping apparatuses according to second to fourth modification examples of the embodiment, which are described later.

As illustrated in FIG. 4, in the three-dimensional shaping apparatus 100 described above, the gap is present between the peripheral portion 173 of the nozzle 170 and the flow path forming unit 162.

In contrast, as illustrated in FIG. 7, in the three-dimensional shaping apparatus 200, the peripheral portion 173 of the nozzle 170 contacts the flow path forming unit 162. In other words, the part of the nozzle 170 other than the second screw portion 171 also contacts the flow path forming unit 162. In the illustrated example, the peripheral portion 173 forms the upper surface of the nozzle 170. For example, the contact area between the peripheral portion 173 and the flow path forming unit 162 is larger than the contact area between the second screw portion 171 and the flow path forming unit 162.

In the three-dimensional shaping apparatus 200, the nozzle 170 includes the peripheral portion 173 provided in the periphery of the second screw portion 171, and the peripheral portion 173 contacts the flow path forming unit 162. Thus, in the three-dimensional shaping apparatus 200, the contact area between the nozzle 170 and the flow path forming unit 162 can be increased due to the peripheral portion 173, and the heat of the heating unit 168 is easily transmitted to the distal end of the nozzle 170.

### 2.2. Second Modification Example

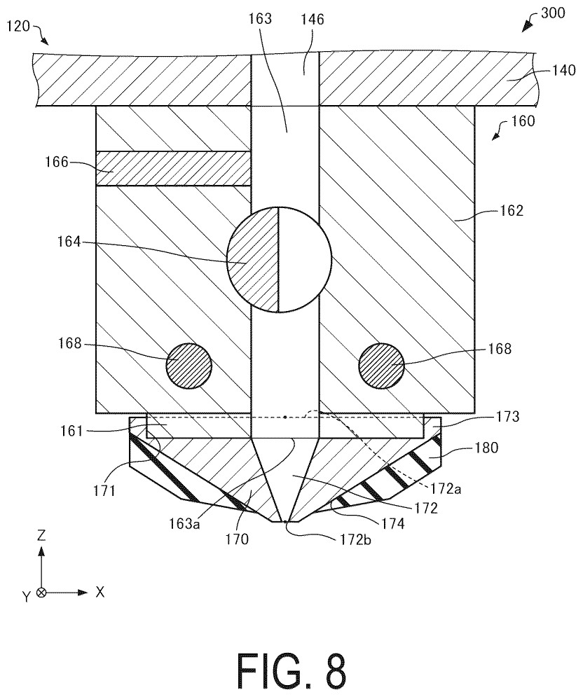

Next, a three-dimensional shaping apparatus according to a second modification example of the embodiment is described with reference to the drawings. FIG. 8 is a cross-sectional view schematically illustrating the nozzle unit 160 of a three-dimensional shaping apparatus 300 according to a second modification example of the embodiment.

As illustrated in FIG. 8, the three-dimensional shaping apparatus 300 is different from the three-dimensional shaping apparatus 100 described above in that a low thermal conductivity portion 180 is provided.

The low thermal conductivity portion 180 is provided to the side surface 174 of the nozzle 170. The thermal conductivity of the low thermal conductivity portion 180 is lower than the thermal conductivity of the nozzle 170. The material of the low thermal conductivity portion 180 is ceramic, for example. The low thermal conductivity portion 180 is a grip portion to be gripped when the second screw portion 171 of the nozzle 170 is fastened with or released from the first screw portion 161 of the flow path forming unit 162.

The three-dimensional shaping apparatus 300 includes the low thermal conductivity portion 180 that is provided to the side surface 174 of the nozzle 170 and has thermal conductivity lower than that of the nozzle 170. Thus, in the three-dimensional shaping apparatus 300, the heat transmitted from the nozzle 170 to the heating unit 168 can be retained due to the low thermal conductivity portion 180. With this, the heat of the heating unit 168 is easily transmitted to the distal end of the nozzle 170.

Note that, in place of the low thermal conductivity portion 180, a grip portion having the same thermal conductivity as the nozzle 170 may be provided. In such a case, the material of the grip portion may be the same material as the nozzle 170.

### 2.3. Third Modification Example

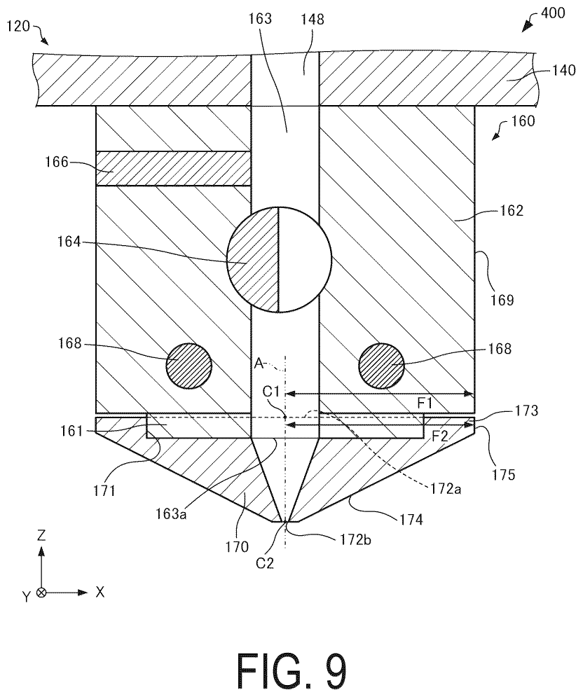

Next, a three-dimensional shaping apparatus according to a third modification example of the embodiment is described with reference to the drawings. FIG. 9 is a cross-sectional view schematically illustrating the nozzle unit 160 of a three-dimensional shaping apparatus 400 according to a third modification example of the embodiment.

As illustrated in FIG. 9, the three-dimensional shaping apparatus 400 is different from the three-dimensional shaping apparatus 100 described above in that the side surface 174 of the nozzle 170 includes an erect portion 175 where the distance to the center line A is the same as a distance F1 between the center line A and a side surface 169 of the flow path forming unit 162. A distance F2 between the center line A and the erect portion 175 is the same as the distance F1 between the center line A and the side surface 169.

In the three-dimensional shaping apparatus 400, the side surface 174 of the nozzle 170 includes the erect portion 175 being a part where the distance to the center line A is the same as the distance F1 between the center line A and the side surface 169 of the flow path forming unit 162. Thus, in the three-dimensional shaping apparatus 400, the heat of the heating unit 168 can easily be transmitted to the distal end of the nozzle 170 while reducing the size and the weight of the nozzle 170.

### 2.4. Fourth Modification Example

Next, a three-dimensional shaping apparatus according to a fourth modification example of the embodiment is described with reference to the drawings.

In the three-dimensional shaping apparatus 100 described above, the material stored in the material storage unit 110 is an ABS resin.

In contrast, in a three-dimensional shaping apparatus according to a fourth modification example of the embodiment, the material stored in the material storage unit 110 is a material other than an ABS resin or a material obtained by adding other components to an ABS resin.

Examples of the material stored in the material storage unit 110 may include materials containing various materials, such as a thermoplastic material, a metal material, and a ceramic material, as a main material. Here, the “main material” indicates a main material that forms a shape of an object that is three-dimensionally shaped by the three-dimensional shaping apparatus, and indicates a material that constitutes 50 mass % or more of a three-dimensionally shaped object. The materials described above include a material in which the main material is melted alone and a paste-like material in which some components contained together with the main material are melted.

As the thermoplastic material, a thermoplastic resin may be used, for example. Examples of the thermoplastic resin include general-purpose plastic, general-purpose engineering plastic, and super engineering plastic.

Examples of the general-purpose plastic include polypropylene (PP), polyethylene (PE), polyvinyl chloride (PVC), and polylactic acid (PLA).

Examples of the general-purpose engineering plastic include polyacetal (POM), polyamide (PA), polycarbonate (PC), modified polyphenylene ether (m-PPE), polybutylene terephthalate (PBT), and polyethylene terephthalate (PET).

Examples of the super engineering plastic include polysulfone (PSU), polyether sulfone (PES), polyphenylene sulfide (PPS), polyarylate (PAR), polyimide (PI), polyamide-imide (PAI), polyetherimide (PEI), and polyetheretherketone (PEEK).

An additive such as pigment, metal, ceramic, wax, a flame retardant, an antioxidant, and a thermal stabilizer may be added to the thermoplastic material. The thermoplastic material is plasticized and converted into a molten state in the plasticizing unit 120 by the rotation of the flat screw 130 and the heating by the heating unit 150. Further, the plasticized material thus generated is ejected from the nozzle unit 160, is stacked on the stage 20, and then is cured as the temperature is reduced.

For example, in the plasticizing unit 120, a metal material may be used as the main material in place of the above-mentioned thermoplastic material. In such a case, a component that is melted during generation of the plasticized material may be mixed into a powder material that is obtained by pulverizing a metal material, and the resultant may be put into the plasticizing unit 120.

Examples of the metal material include single metals such as magnesium (Mg), iron (Fe), cobalt (Co), chromium (Cr), aluminum (Al), titanium (Ti), copper (Cu), and nickel (Ni), alloys containing one or more of those metals, maraging steel, stainless steel, cobalt-chromium-molybdenum, titanium alloys, nickel alloys, aluminum alloys, cobalt alloys, and cobalt-chromium alloys.

In the plasticizing unit 120, a ceramic material may be used in place of the above-mentioned metal material. Examples of the ceramic material include oxide ceramics such as silicon dioxide, titanium dioxide, aluminum oxide, and zirconium oxide, and non-oxide ceramics such as aluminum nitride.

The powder material such as a metal material and a ceramic material stored in the material storage unit 110 may be a mixed material in which a plurality of powder types such as single metal powder, alloy powder, and ceramic material powder are blended. Further, for example, the powder material such as a metal material and a ceramic material may be coated with the above-mentioned thermoplastic resin or other thermoplastic resins. In such a case, in the plasticizing unit 120, the thermoplastic resin may be melted to exert fluidity.

For example, a solvent may be added to the powder material such as a metal material and a ceramic material stored in the material storage unit 110. Examples of the solvent include water; (poly)alkylene glycol monoalkyl ethers such as ethylene glycol monomethyl ether, ethylene glycol monoethyl ether, propylene glycol monomethyl ether, and propylene glycol monoethyl ether; acetate esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (for example, tetrabutylammonium acetate); and ionic liquids such as butyl carbitol acetate.

In addition, for example, a binder may be added to the powder material such as a metal material and a ceramic material stored in the material storage unit 110. Examples of the binder include an acrylic resin, an epoxy resin, a silicone resin, a cellulose-based resin, or other synthetic resins, or PLA, PA, PPS, PEEK, or other thermoplastic resins.

### 3. Experimental Example

In an experimental example, a simulation was performed by using a volume-of-fluid (VOF) method by FLOW-3D.

A model M1 used in the simulation was a model according to an example. Specifically, the model M1 was a model of a nozzle unit in which a length of a nozzle in a direction orthogonal to a direction of a center line was equal to or more than twice a length thereof in the direction of the center line. Further, in the model M1, all side surfaces of the nozzle were positioned outside a cone having an apex at a center of an ejection port, a height equal to a distance between a center of an introduction port and a center of the ejection port, and a right vertex angle.

A model M2 used in the simulation was a model according to a comparative example. Specifically, the model M2 was a model of a nozzle unit in which a length of a nozzle in a direction orthogonal to a direction of a center line is less than twice a length thereof in the direction of the center line. Further, in the model M2, at least some of surfaces of the nozzle were positioned inside a cone having an apex at a center of an ejection port, a height equal to a distance between a center of an introduction port and a center of the ejection port, and a right vertex angle.

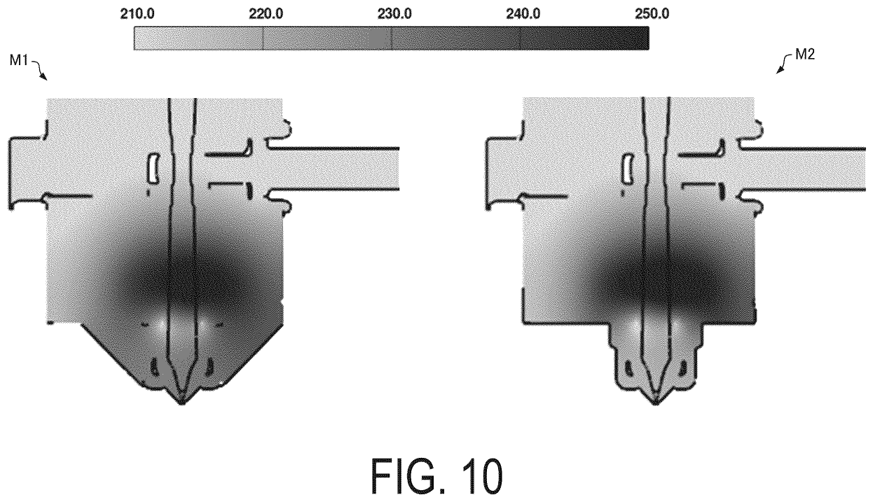

FIG. 10 is a diagram for describing a result of a simulation. In FIG. 10, the higher temperature is expressed by the deeper color. In each of the models M1 and M2, the set temperature of the heater provided to the flow path forming unit was 250 degrees Celsius. AS illustrated in FIG. 10, in the model M2, the temperature at the distal end of the nozzle was approximately 220 degrees Celsius. In contrast, in the model M1, the temperature at the distal end of the nozzle was approximately 235 degrees Celsius. Therefore, it is understood that the heat of the heating unit was easily transmitted to the distal end of the nozzle in the model M1 as compared to the model M2.

The embodiment and the modifications described above are merely examples, and are not intended as limiting. For example, each embodiment and each modification can also be combined together as appropriate.

The present disclosure includes configurations that are substantially identical to the configurations described in the embodiment, for example, configurations with identical functions, methods and results, or with identical advantages and effects. Also, the present disclosure includes configurations obtained by replacing non-essential portions of the configurations described in the embodiment. In addition, the present disclosure also includes configurations that achieve the same effects as the configurations described in the embodiments or configurations that can achieve the same advantages. Further, the present disclosure includes configurations obtained by adding known techniques to the configurations described in the embodiment.

The following contents are derived from the embodiment and the modification examples described above.

According to an aspect, a three-dimensional shaping apparatus includes a plasticizing unit configured to plasticize a material and generate plasticized material, a flow path forming unit communicating with the plasticizing unit and including a flow path through which the plasticized material flows, a nozzle being coupled to the flow path forming unit and being configured to eject the plasticized material, and a heating unit being provided to the flow path forming unit and being configured to heat the plasticized material, wherein the nozzle includes an introduction port communicating with the flow path and being configured to introduce the plasticized material, and an ejection port communicating with the introduction port and being configured to eject the plasticized material, and a length of the nozzle in a direction orthogonal to a direction of a center line passing through a center of the introduction port and a center of the ejection port is equal to or more than twice a length thereof in the direction of the center line.

According to the three-dimensional shaping apparatus, the heat of the heating unit is easily transmitted to the distal end of the nozzle.

According to an aspect, a three-dimensional shaping apparatus includes a plasticizing unit configured to plasticize a material and generate plasticized material, a flow path forming unit communicating with the plasticizing unit and including a flow path through which the plasticized material flows, a nozzle being coupled to the flow path forming unit and being configured to eject the plasticized material, and a heating unit being provided to the flow path forming unit and being configured to heat the plasticized material, wherein the nozzle includes an introduction port communicating with the flow path and being configured to introduce the plasticized material, and an ejection port communicating with the introduction port and being configured to eject the plasticized material, and all side surfaces of the nozzle are positioned outside a cone having an apex at the center of the ejection port, a height equal to a distance between the center of the introduction port and the center of the ejection port, and a right vertex angle.

According to the three-dimensional shaping apparatus, the heat of the heating unit is easily transmitted to the distal end of the nozzle.

In the aspect of the three-dimensional shaping apparatus, the flow path forming unit may include a first screw portion provided to a part corresponding to an outlet of the flow path, the nozzle may include a second screw portion being provided to a part corresponding to the introduction port and being configured to be fastened with the first screw portion, and a length of the first screw portion in the direction orthogonal to the direction of the center line passing through the center of the introduction port and the center of the ejection port may be more than a length thereof in the direction of the center line.

According to the three-dimensional shaping apparatus, the heat of the heating unit is easily transmitted to the distal end of the nozzle.

In the aspect of the three-dimensional shaping apparatus, the nozzle may include a peripheral portion provided in a periphery of the second screw portion, and the peripheral portion may contact with the flow path forming unit.

According to the three-dimensional shaping apparatus, the contact area between the nozzle and the flow path forming unit can be increased due to the peripheral portion.

According to the aspect, the three-dimensional shaping apparatus may include a stage including a stacking surface on which the plasticized material is stacked, wherein, for all of the side surfaces of the nozzle, a distance between the side surface of the nozzle and the stacking surface may be less than a distance between the ejection port and the stacking surface.

According to the three-dimensional shaping apparatus, the possibility that the nozzle contacts the stage or a shaped object can be lowered.

In the aspect of the three-dimensional shaping apparatus, a distance between the nozzle and the heating unit may be less than a distance between the plasticizing unit and the heating unit.

According to the three-dimensional shaping apparatus, the distance between the heating unit and the distal end of the nozzle can be reduced.

In the aspect of the three-dimensional shaping apparatus, thermal conductivity of the nozzle may be higher than thermal conductivity of the flow path forming unit.

According to the three-dimensional shaping apparatus, the heat of the heating unit is easily transmitted to the distal end of the nozzle.

In the aspect of the three-dimensional shaping apparatus, a side surface of the nozzle may include a part where a distance to the center line passing through the center of the introduction port and the center of the ejection port is equal to a distance between the center line and a side surface of the flow path forming unit.

According to the three-dimensional shaping apparatus, the heat of the heating unit can easily be transmitted to the distal end of the nozzle while reducing the size and the weight of the nozzle.

According to the aspect, the three-dimensional shaping apparatus may include a low thermal conductivity portion being provided to a side surface of the nozzle and having thermal conductivity lower than that of the nozzle.

According to the three-dimensional shaping apparatus, the heat transmitted from the heating unit to the nozzle can be retained.

What is claimed is:

1. A three-dimensional shaping apparatus comprising:
a plasticizing unit configured to plasticize a material and generate plasticized material;
a flow path forming unit communicating with the plasticizing unit and including a flow path through which the plasticized material flows;
a nozzle being coupled to the flow path forming unit and being configured to eject the plasticized material; and
a heating unit being provided to the flow path forming unit and being configured to heat the plasticized material, wherein
the nozzle includes:
an introduction port communicating with the flow path and being configured to introduce the plasticized material; and
an ejection port communicating with the introduction port and being configured to eject the plasticized material, and
a length of the nozzle in a direction orthogonal to a direction of a center line passing through a center of the introduction port and a center of the ejection port is equal to or more than twice a length thereof in the direction of the center line.

2. A three-dimensional shaping apparatus comprising:
a plasticizing unit configured to plasticize a material and generate plasticized material;
a flow path forming unit communicating with the plasticizing unit and including a flow path through which the plasticized material flows;
a nozzle being coupled to the flow path forming unit and being configured to eject the plasticized material; and
a heating unit being provided to the flow path forming unit and being configured to heat the plasticized material, wherein
the nozzle includes:
an introduction port communicating with the flow path and being configured to introduce the plasticized material; and
an ejection port communicating with the introduction port and being configured to eject the plasticized material, and
all side surfaces of the nozzle are positioned outside a cone having an apex at the center of the ejection port, a height equal to a distance between the center of the introduction port and the center of the ejection port, and a right vertex angle.

3. A three-dimensional shaping apparatus according to claim 1, wherein
the flow path forming unit includes a first screw portion provided to a part corresponding to an outlet of the flow path,
the nozzle includes a second screw portion being provided to a part corresponding to the introduction port and being configured to be fastened with the first screw portion, and
a length of the first screw portion in the direction orthogonal to the direction of the center line passing through the center of the introduction port and the center of the ejection port is more than a length thereof in the direction of the center line.

4. A three-dimensional shaping apparatus according to claim 3, wherein
the nozzle includes a peripheral portion provided in a periphery of the second screw portion, and
the peripheral portion contacts the flow path forming unit.

5. A three-dimensional shaping apparatus according to claim 1, comprising:
a stage including a stacking surface on which the plasticized material is stacked, wherein
for all of the side surfaces of the nozzle, a distance between the side surface of the nozzle and the stacking surface is less than a distance between the ejection port and the stacking surface.

6. A three-dimensional shaping apparatus according to claim 1, wherein
a distance between the nozzle and the heating unit is less than a distance between the plasticizing unit and the heating unit.

7. A three-dimensional shaping apparatus according to claim 1, wherein
thermal conductivity of the nozzle is higher than thermal conductivity of the flow path forming unit.

8. A three-dimensional shaping apparatus according to claim 1, wherein
a side surface of the nozzle includes a part where a distance to the center line passing through the center of the introduction port and the center of the ejection port is equal to a distance between the center line and a side surface of the flow path forming unit.

9. A three-dimensional shaping apparatus according to claim 1, comprising:
a low thermal conductivity portion being provided to a side surface of the nozzle and having thermal conductivity lower than that of the nozzle.
